(19) United States
(12) Patent Application Publication
(10) Pub. No.: US 2023/0169802 A1
(43) Pub. Date: Jun. 1, 2023

(54) SYSTEMS AND METHODS FOR VEHICLE ANALYTICS

(71) Applicant: STEERING SOLUTIONS IP HOLDING CORPORATION, Saginaw, MI (US)

(72) Inventors: Bernard C. Robinson, Grand Blanc, MI (US); Peter D. Schmitt, Farmington Hills, MI (US); Andrew J. Frank, Rochester Hills, MI (US); Jonathan Hirscher, Highland, MI (US); Owen K. Tosh, Saginaw, MI (US); Michael R. Story, Bay City, MI (US); Emilio Quaggiotto, Birmingham, MI (US); Joachim J. Klesing, Rochester, MI (US)

(21) Appl. No.: 18/071,892

(22) Filed: Nov. 30, 2022

Related U.S. Application Data
(60) Provisional application No. 63/284,610, filed on Nov. 30, 2021.

(51) Int. Cl. G07C 5/04

(52) U.S. Cl. CPC G07C 5/04

(57) ABSTRACT

A method for vehicle analytics includes receiving data from at least one condition indicator sensor of a vehicle and receiving data from at least one usage indicator sensor of the vehicle. The method also includes updating a vehicle specific model corresponding to a vehicle master model, based on the data from the at least one condition indicator sensor and the at least one usage indicator sensor. The method also includes identifying, using the vehicle specific model, at least one usage trend of the vehicle and determining an estimate of a remaining useful life of at least one aspect of the vehicle based on the at least one usage trend of the vehicle.

### CROSS-REFERENCES TO RELATED APPLICATIONS

This patent application claims priority to U.S. Provisional Patent Application Ser. No. 63/284,610, filed Nov. 30, 2021 which is incorporated herein by reference in its entirety.

### TECHNICAL FIELD

This disclosure relates to vehicle analytics and in particular to systems and methods determining a value of a vehicle based on the vehicle analytics.

### BACKGROUND OF THE INVENTION

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, or other suitable steering system. The steering system of such a vehicle typically controls various aspects of vehicle steering including providing steering assist to an operator of the vehicle, controlling steerable wheels of the vehicle, and the like.

### SUMMARY OF THE INVENTION

This disclosure relates generally to vehicle analytics.

An aspect of the disclosed embodiments includes a method for vehicle analytics. The method includes receiving data from at least one condition indicator sensor of a vehicle and receiving data from at least one usage indicator sensor of the vehicle. The method also includes updating a vehicle specific model corresponding to a vehicle master model, based on the data from the at least one condition indicator sensor and the at least one usage indicator sensor. The method also includes identifying, using the vehicle specific model, at least one usage trend of the vehicle and determining an estimate of a remaining useful life of at least one aspect of the vehicle based on the at least one usage trend of the vehicle.

Another aspect of the disclosed embodiments includes a method for vehicle analytics. The method includes receiving data from at least one condition indicator sensor of a vehicle, receiving data from at least one usage indicator sensor of the vehicle, and updating a vehicle specific model based on a vehicle master model, the data from the at least one condition indicator sensor, and the at least one usage indicator sensor, the vehicle master model represents a class of vehicle corresponding to a vehicle design associated with the vehicle and the vehicle specific model is generated based on the vehicle master model and at least one initial parameter corresponding to at least one end-of-line characteristic of the vehicle. The method also includes identifying, using the vehicle specific model, at least one usage trend of the vehicle, and determining an estimate of a remaining useful life of at least one aspect of the vehicle based on the at least one usage trend of the vehicle.

Another aspect of the disclosed embodiments includes a system for vehicle analytics. The system includes a processor and a memory. The memory includes instructions that, when executed by the processor, cause the processor to: receive data from at least one condition indicator sensor of a vehicle; receive data from at least one usage indicator sensor of the vehicle; update a vehicle specific model based on a vehicle master model, the data from the at least one condition indicator sensor, and the at least one usage indicator sensor, the vehicle master model represents a class of vehicle corresponding to a vehicle design associated with the vehicle and the vehicle specific model is generated based on the vehicle master model and at least one initial parameter corresponding to at least one end-of-line characteristic of the vehicle; identify, using the vehicle specific model, at least one usage trend of the vehicle; and determine an estimate of a remaining useful life of at least one aspect of the vehicle based on the at least one usage trend of the vehicle.

Another aspect of the disclosed embodiments includes an apparatus for vehicle analytics. The apparatus includes a processor and a memory. The memory includes instructions that, when executed by the processor, cause the processor to: receive data from at least one condition indicator sensor associated with at least one component of a steering system of a vehicle; receive data from at least one usage indicator sensor of the vehicle; receive data from a health management system associated with a vehicle manufacturer logistics system; update a vehicle specific model based on a vehicle master model, the data from the at least one condition indicator sensor, and the at least one usage indicator sensor, the vehicle master model represents a class of vehicle corresponding to a vehicle design associated with the vehicle and the vehicle specific model is generated based on the vehicle master model and at least one initial parameter corresponding to at least one end-of-line characteristic of the vehicle; identify, using the vehicle specific model, at least one usage trend of the vehicle; and determine an estimate of a remaining useful life of at least one aspect of the vehicle based on the at least one usage trend of the vehicle and the data from the health management system.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIG. 2 generally illustrates a controller according to the principles of the present disclosure.

FIG. 3 generally illustrates a vehicle analytics system according to the principles of the present disclosure.

FIG. 4 is a flow diagram generally illustrating a vehicle analytics method according to the principles of the present disclosure.

FIG. 5 is a flow diagram generally illustrating an alternative vehicle analytics method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, or other suitable steering system. The steering system of such a vehicle typically controls various aspects of vehicle steering including providing steering assist to an operator of the vehicle, controlling steerable wheels of the vehicle, and the like.

In addition, vehicles include various other systems and components, all of which are subject changes over time due to wear, tear, abuse, failure, and the like (e.g., including the steering system). Changes to such components may reduce a monetary value of the vehicle or a remaining useful like of the vehicle and/or one or more components of the vehicle (e.g., which in turn may reduce the monetary value of the vehicle).

Typically, a prospective buyer of a pre-owned vehicle has to rely on visual inspection of the vehicle, vehicle age, a test drive of the vehicle, and/or a record of prior accidents. Importantly, the perspective buyer may not have a mechanism for determining whether any incipient, early stage failures or damage (e.g., that are not easily visible and/or cannot be felt or identified during a test drive) may be occurring or may occur in the relatively new feature. For example, the vehicle may include a cut boot in the steering system that may lead to corrosion that impacts steering feel over time, an incipient failure to a component of a transmission of the vehicle, an incipient failure to a component of a motor of the vehicle, and the like. Additionally, or alternatively, the perspective buyer of the vehicle may not have a mechanism for knowing whether a previous owner or operator of the vehicle has abused the vehicle in any way, what the remaining useful life (RUL) of the vehicle is, and various other aspects of the vehicle that may determine or contribute to the overall value of the vehicle. Further, the perspective buyer may not have access to (e.g., because it may not exist) an objective, all-encompassing metric that determines the condition of the vehicle.

Accordingly, systems and methods, such as those described herein, configured to provide a vehicle quality report, may be desirable. In some embodiments, the systems and methods described herein may be configured to automatically calculate a value of a pre-owned vehicle based on health indicators and RUL metrics by vehicle component. The systems and methods described herein may be configured to generate an output that includes various information associated with the vehicle. The output may include a report or other suitable output. The systems and methods described herein may be configured to provide the output to a suitable display, such as the display of a computing device associated with the perspective buyer, a computing device associated with a seller of the vehicle, a computing device associated with a vehicle dealership, or other suitable computing device or display.

The various information of the output may include measurement information associated with a component of the vehicle, replacement information associated with a component of the vehicle, replacement and/or repair information (e.g., such as cost, component identifier, and the like) of a component of the vehicle, incipient failure or damage associated with a component or system of the vehicle, a total estimate cost to repair the vehicle, a total monetary value of the vehicle, other suitable information, or a combination thereof. In a non-limiting example, the output may include information as follows:
Tire profile: 3 mil, needs replacement in 6 months, cost $400
Steering system: early stages of corrosion, Remaining Useful Life:
1 year, replacement cost $1500
Brake Pads: new, RUL: 3 years
Estimated total repair cost to 5 years RUL: $2000
Estimated Vehicle Value from component life: $15000

It should be understood that, while limited examples of the output are provided, the systems and methods described herein may be configured to provide an output that includes any suitable information in any suitable format.

In some embodiments, the systems and methods described herein may be configured to use various aspects or apply various principles of one or more vehicle management standards, such as the Integrated Vehicle Health Management (IVHM) standard provided by the Society of Automotive Engineers (SAE JA 6268) and/or other suitable standard.

In some embodiments, the systems and methods described herein may be configured to provide a vehicle model (e.g., which may be referred to as a digital twin of a vehicle) that is stored and processed on a remotely located computing device, such as a cloud server or other suitable remotely located computing device. The vehicle model may mirror static properties and/or dynamic behavior of the vehicle and vehicle subsystems. The vehicle model may include a virtual representation of a component for the purpose of detecting component failures or generating information about the operating environment (e.g., road condition or other suitable aspects of the operating environment) or for any other suitable purpose. In some embodiments, the vehicle model may be referred to as a vehicle specific model (e.g., representing specific aspects of the vehicle), which may be generated based on a vehicle master model (e.g., a model representing a standard version of the vehicle) and information received from sensors, controllers, and the like of the vehicle.

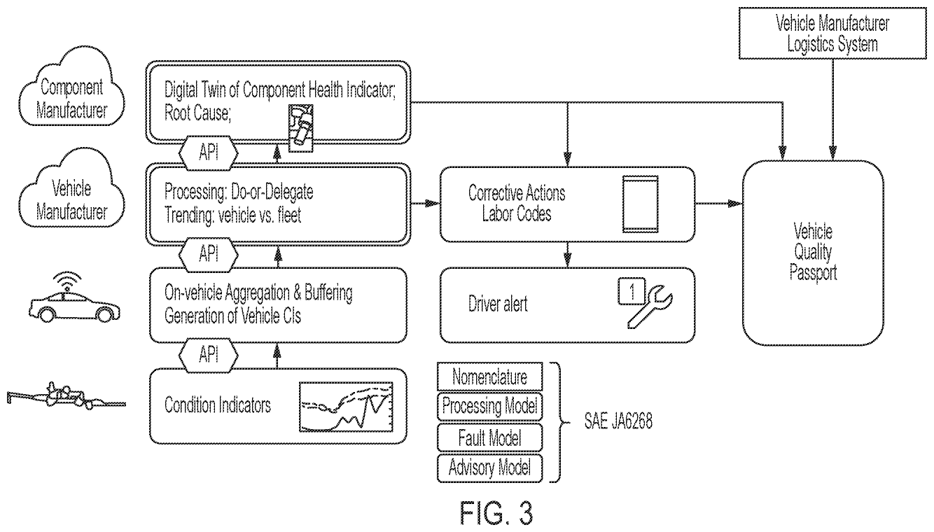

In some embodiments, as is generally illustrated in FIG. 3, the systems and methods described herein may be configured to use the IVHM framework including a digital twin connected to vehicle passport condition and usage indicators, which are collected in the vehicle for every component so that a trend can be calculated. The indicators may include or be associated with one or more sensors of the vehicle. For example, the friction estimation in a steering gear constitutes such an indicator that increases as corrosion in the gear increases. In some embodiments, The IVHM framework may be connected to one or more vehicle manufacturer logistics systems (e.g., associated with the vehicle or other vehicles in a fleet or other suitable vehicles). The logistics system may include or provide information associated with the cost for component or vehicle replacement, freight and the like.

In some embodiments, the systems and methods described herein may be configured to determine an end-of-life cut-off using at least one of fault injection tests during product development, values of at least one condition indicator of customer field returns (e.g., a condition indicator may include a real or virtual sensor that captures values that characterize the functional degradation of a component or system of the vehicle, where the values may be aggregated via the remote computing device), a historic plot of usage indicators that indicate historical usage (e.g., by an owner or operator) of the vehicle, other suitable information, or a combination thereof.

In some embodiments, the systems and methods described herein may be configured to generate a vehicle estimate value by comparing and correlating usage indicator plots with field returns (e.g., for vehicles in a fleet of vehicles or other suitable vehicles). The systems and methods described herein may be configured to generate an estimation of the RUL for the vehicle or one or more components of the vehicle by extrapolation of the trend (e.g., associated with the plots) over time.

In some embodiments, the systems and methods described herein may be configured to aggregate the usage indicators and condition indicators for the each vehicle of a plurality of vehicles (e.g., where the usage indicators and condition indicators for each vehicle are automatically collected via one or more connected vehicle service or mechanism). The systems and methods described herein may be configured to, for the vehicle, compare the aggregated usage indicators and condition indicators to an average (e.g., or typical) value from a median user (e.g., buyer, seller, and the like of the systems and methods described herein).

In some embodiments, the systems and methods described herein may be configured to provide an output that summarized hidden, value reducing failures of one or more components of the vehicle, RUL based on physics based metrics (e.g., condition indicators, usage indicators, health indicators, and/or other suitable indicators or information). In some embodiment, the output may correspond to an extension to an IVHM system. In some embodiments, the output may be linked to a dealership logistics system. The system and methods described herein may be configured to determine vehicle and component costs using the dealer logistics system.

In some embodiment, the system and methods described herein may be configured to estimate a monetary value of the vehicle. The system and methods described herein may be configured to provide information to a perspective buyer of the vehicle indicating a history and degree of abusive use or other suitable use of the operator or operators of the vehicle compared to the average operator of a similar vehicle or any suitable vehicle. The system and methods described herein may be configured to provide access (e.g., a suitable display and/or interface) to the output to an owner or operator of the vehicle, a perspective buyer of the vehicle, any other suitable person or entity. The system and methods described herein may be configured to one or more features for sharing the output to any suitable person or entity (e.g., via the suitable display and/or interface).

In some embodiments, the systems and methods described herein may be configured to receive data from at least one condition indicator sensor of a vehicle. The at least one condition indicator sensor may include any suitable sensor and may correspond to at least one component of the vehicle, such as, at least one component of a steering system of the vehicle, at least one component of a braking system of the vehicle, at least one component of a motor of the vehicle, at least one component of a transmission of the vehicle, and/or any other suitable component.

The system and methods described herein may be configured to receive data from at least one usage indicator sensor of the vehicle. The data corresponding to the at least one usage indicator sensor may indicate a usage (e.g., by an operator of the vehicle) of a component (e.g., any suitable component including, but not limited, to those described herein) of the vehicle associated with the at least one usage indicator sensor.

The system and methods described herein may be configured to update a vehicle specific model corresponding to a vehicle master model, based on the data from the at least one condition indicator sensor and the at least one usage indicator sensor. The system and methods described herein may be configured to identify, using the vehicle specific model, at least one usage trend of the vehicle. The systems and methods described herein may be configured to determine an estimate of an RUL of at least one aspect of the vehicle based on the at least one usage trend of the vehicle.

In some embodiments, the system and methods described herein may be configured to receive data from a health management system associated with a vehicle manufacturer logistics system. The system and methods described herein may be configured to identify, using the vehicle specific model, at least one hidden value reducing failure of the vehicle. The system and methods described herein may be configured to determine a monetary value of the vehicle based on the at least one hidden value reducing failure of the vehicle and the estimate of the RUL of the at least one aspect of the vehicle.

In some embodiments, the systems and methods described herein may be configured to receive data from at least one condition indicator sensor of a vehicle. The at least one condition indicator sensor may be associated with at least one component of the vehicle. The at least one component may correspond to a steering system of the vehicle or other suitable aspect of the vehicle. The systems and methods described herein may be configured to receive data from at least one usage indicator sensor of the vehicle. the at least one usage indicator sensor may indicate a usage of the at least one component of the vehicle associated with the at least one usage indicator sensor

The systems and methods described herein may be configured to update a vehicle specific model based on a vehicle master model, the data from the at least one condition indicator sensor, the at least one usage indicator sensor, any other suitable data or information, or a combination thereof. The vehicle master model may represent a class of vehicle corresponding to a vehicle design associated with the vehicle. The vehicle specific model may be generated based on the vehicle master model and at least one initial parameter corresponding to at least one end-of-line characteristic of the vehicle.

The systems and methods described herein may be configured to identify, using the vehicle specific model, at least one usage trend of the vehicle. The systems and methods described herein may be configured to determine an estimate of a remaining useful life of at least one aspect of the vehicle based on the at least one usage trend of the vehicle.

The systems and methods described herein may be configured to receive data from a health management system associated with a vehicle manufacturer logistics system. The systems and methods described herein may be configured to determine the estimate of the remaining useful life of the at least one aspect of the vehicle further based on the data from the health management system.

The systems and methods described herein may be configured to determine the estimate of the remaining useful life of the vehicle further based on at least one physics based metric. The systems and methods described herein may be configured to identify, using the vehicle specific model, at least one hidden value reducing failure of the vehicle. The systems and methods described herein may be configured to determine a monetary value of the vehicle based on the at least one hidden value reducing failure of the vehicle and the estimate of the remaining useful life of the at least one aspect of the vehicle.

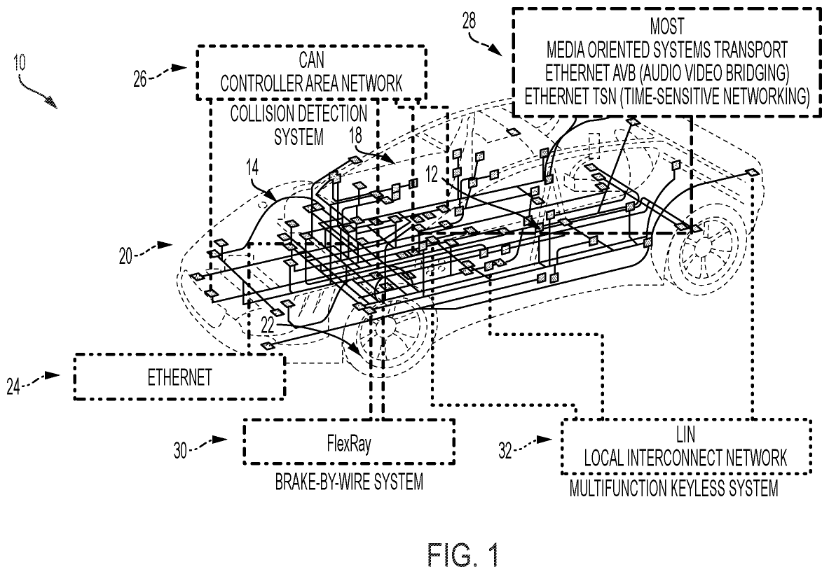

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a steering wheel, and other such components are disposed in the passenger compartment 18 of the vehicle 10. The propulsion controls may be actuated or controlled by a driver of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), or other suitable steering system. The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof. Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

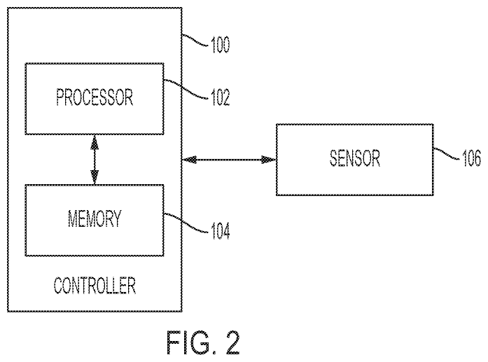

In some embodiments, the vehicle 10 may include a controller, such as controller 100, as is generally illustrated in FIG. 2. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, one or more transition sensors or devices, one or more proximity sensors or devices, one or more vehicle usage sensors or devices, one or more vehicle propulsion sensors or devices, other suitable sensors or devices, or a combination thereof. The one or more signals may indicate a handwheel torque, a handwheel angel, a motor velocity, a vehicle speed, other suitable information, or a combination thereof.

In some embodiments, the controller 100 and/or a suitable computing device may receive one or more design specification characteristics corresponding to a vehicle steering system design and/or other systems of subsystems of a class of vehicle corresponding to the vehicle 10 and/or may receive input indicating engineering and/or design information corresponding to engineering and/or design specifications of a class of vehicle corresponding to the vehicle 10 and/or other vehicles. The other vehicles may include features similar to or different from the vehicle 10. The engineering and/or design information may include engineering tolerances, component model number or specification, component dimensions (e.g., weight, length, width, depth, and the like), component features (e.g., functions that various components are capable of performing), sensor location, controller type, any other suitable engineering and design specification, or a combination thereof of vehicle steering system design and/or other systems or subsystems of the vehicle 10. Additionally, or alternatively, the one or more design specification characteristics may include warranty information, sales information, safety feature information, recall information, other suitable information, or a combination thereof of the class of vehicle steering system and/or the systems or subsystems corresponding to the class of vehicle. It should be understood that the vehicle 10 and other the vehicles may belong to or be associated with the same or different classes of vehicle and may include the same or different classes of vehicle steering systems.

In some embodiments, the controller 100 and/or other suitable computing device may receive one or more end-of-line characteristics of a vehicle steering system that includes the vehicle steering system design and/or other subsystems or systems of the vehicle 10. The end-of-line characteristics may include actual manufacturing components used during production of the vehicle steering system, the class of vehicle steering system, the vehicle 10, and/or the class of vehicle corresponding to the vehicle 10. Additionally, or alternatively, the end-of-line characteristics may include production measurements, production tolerances, other suitable production information, or a combination thereof of the vehicle steering system, the class of vehicle steering system, the vehicle 10, and/or the class of vehicle corresponding to the vehicle 10.

In some embodiments, the controller 100 may receive or generate a master vehicle model of the vehicle steering system design, the class of vehicle associated with the vehicle 10, and/or the class or classes of vehicle corresponding to the other vehicles using the one or more design specification characteristics. Additionally, or alternatively, the controller 100 may receive or generate a master vehicle model of the vehicle steering system design, the class of vehicle associated with the vehicle 10, and/or the class or classes of vehicle corresponding to the other vehicles using the one or more design specification characteristics and the one or more end-of-line characteristics. For example, the master vehicle model may correspond to the vehicle steering system design (e.g., the class of vehicle steering systems corresponding to the vehicle steering system of the vehicle 10 and/or the other vehicles). In some embodiments, the controller 100 may retrieve or receive the master vehicle model from another computing device, the vehicle 10 and/or the other vehicles, any other suitable location, or a combination thereof.

The master vehicle model may include a digital representation of the vehicle steering system design, the class of vehicle associated with the vehicle 10, and/or the class or classes of vehicle corresponding to the other vehicles. The controller 100 may generate or receive at least one initial parameter or parameter set (e.g., a signature) using the one or more end-of-line characteristics of the vehicle steering system, the vehicle 10, and/or the other vehicles. For example, the controller 100 may generate or receive a parameter set corresponding to the vehicle steering system of the vehicle 10. The parameter set may include a value, such as a numeric string, or other suitable value. The parameter set may represent system or component information specific to the vehicle steering system of the vehicle 10. It should be understood that the parameter sets may correspond to other components, systems, or subsystems of the vehicle 10.

In some embodiments, the controller 100 may receive operational data corresponding to the vehicle steering system, the vehicle 10, and/or the other vehicles. The operational data may include vehicle sensor data indicating one or more measurements of the vehicle steering system, the vehicle 10, and/or the other vehicles during operation. For example, the operation data may include sensor data indicating handwheel friction of a handwheel of the vehicle steering system, wheel angle corresponding to an applied handwheel torque, other suitable measurements of the vehicle steering system, or a combination thereof. It should be understood that the controller 100 may receive any suitable operation data corresponding to any system or subsystem of the vehicle 10 and/or the other vehicles.

In some embodiments, the controller 100 may generate or receive at least one subsequent parameter based on the operational data. For example, the controller 100 may generate or receive a parameter or a parameter set indicating the measurements and/or other information corresponding to the operational data. The controller 100 may update the parameter set using the at least one subsequent parameter or parameter set. In some embodiments, the controller 100 may continuously or periodically receive operational data and may continuously or periodically update the parameter set based on the operational data.

In some embodiments, the controller 100 may generate or receive a vehicle specific model based on the master vehicle model and the parameter set. The vehicle specific model may include nominal design data (e.g., computer aided design data), as-built data (e.g., digital trace data), and in-use data. The nominal design data may correspond to the one or more design specification characteristics. The as-build data may correspond to the one or more end-of-line characteristics. The in-use data may correspond to the operational data. In some embodiments, the controller 100 may retrieve or receive the vehicle specific model from another computing device, the vehicle 10, the other vehicles, any other suitable location, or a combination thereof.

The vehicle specific model may include a first constituent model. The first constituent model may include a physics-based model. The first constituent model may receive the nominal design data, the as-build data, the in-use data, any other suitable data, or a combination thereof. The controller 100 may generate or receive the first constituent model using the nominal design data, the as-build data, the in-use data, any other suitable data, or a combination thereof. The first constituent model may represent physical aspects of the vehicle steering system (e.g., and/or the vehicle 10 and the other vehicles). For example, the first constituent model may represent roadwheel angle, tire lateral slip, vehicle heading angle, vehicle yaw rate, other suitable physical aspects of the vehicle steering system, or a combination thereof.

In some embodiments, the vehicle specific model includes a second constituent model. It should be understood that the vehicle specific model may include only the first constituent model, only the second constituent model, both of the first constituent model and the second constituent model, additional constituent models, or any combination of the first constituent model, the second constituent model, and any additional suitable constituent models. The second constituent model may include a machine learning-based model. The second constituent model may be trained using any suitable data corresponding to the vehicle steering system design, the class of vehicle corresponding to the vehicle 10, the other vehicles, the vehicle steering system, any other suitable data, or a combination thereof. The second constituent model may receive the in-use data and/or any other suitable data.

In some embodiments, the first constituent model and/or the second constituent model receive inputs (e.g., steering torque and/or other suitable input) corresponding to the vehicle steering system and/or any suitable system or subsystem of the vehicle 10 (e.g., a steering system a chassis system, other vehicle systems, and the like). The inputs may be generated by a driver of the vehicle 10 and/or sensors (e.g., such as the sensors 106) configured to sense an environment of the vehicle 10 (e.g., road surface information or other suitable input indicating characteristic of the environment).

In some embodiments, the first constituent model and/or the second constituent model receive outputs (e.g., yaw values, acceleration values, other suitable outputs, or a combination thereof) from the sensors of the vehicle 10. The first constituent model may determine one or more intermediate outputs (e.g., such as a rack force or other suitable output). The first constituent model may communicate the one or more intermediate outputs to the second constituent model. The second constituent model may analyze the one or more intermediate outputs and/or the in-use data and may generate one or more predicted parameters (e.g., a current tire radius) or responses of the vehicle steering system. The second constituent model may update the parameter set based on the predicted parameters or responses. The second constituent model may communicate the update parameter set to the first constituent model.

In some embodiments, the controller 100 may be configured to provide information to a suitable computing device, such as those described herein. The computing device may be configured to generate an output indicating a value of the vehicle 10. For example, the controller 100 may receive data from at least one condition indicator sensor of the sensors 106 of the vehicle 10. The at least one condition indicator sensor may include any suitable sensor and may correspond to at least one component of the vehicle 10, such as, at least one component of the steering system of the vehicle 10, at least one component of the braking system of the vehicle 10, at least one component of the motor of the vehicle 10, at least one component of the transmission of the vehicle 10, and/or any other suitable component of the vehicle 10.

The controller 100 may receive data from at least one usage indicator sensor of the sensors 106 of the vehicle 10. The data corresponding to the at least one usage indicator sensor may indicate a usage (e.g., by an operator of the vehicle 10) of a component (e.g., any suitable component including, but not limited, to those described herein) of the vehicle 10 associated with the at least one usage indicator sensor.

The controller 100 and/or the computing device may update the vehicle specific model corresponding to the vehicle master model, based on the data from the at least one condition indicator sensor and the at least one usage indicator sensor. The controller 100 and/or the computing device may identify, using the vehicle specific model, at least one usage trend of the vehicle 10. The controller 100 and/or the computing device may determine an estimate of an RUL of at least one aspect of the vehicle 10 based on the at least one usage trend of the vehicle.

In some embodiments, controller 100 and/or the computing device may receive data from a health management system associated with a vehicle manufacturer logistics system. The controller 100 and/or the computing device may identify, using the vehicle specific model and/or the data from the health management system, at least one hidden value reducing failure of the vehicle 10. The controller 100 may provide various information to the computing device, as described. The computing device may determine a monetary value of the vehicle 10 based on the at least one hidden value reducing failure of the vehicle 10 and the estimate of the RUL of the at least one aspect of the vehicle 10. In some embodiments, the computing device may provide an interface including the output. The interface may include one or more interactive input mechanisms. A user of the interface may provide input using the one or more interactive input mechanisms (e.g., such as input for adjusting the value of the vehicle 10 based on real world or persona experience or knowledge of the user). The computing device may adjust the monetary value of the vehicle 10 based on the input.

In some embodiments, the controller 100 may update the vehicle specific model based on a vehicle master model, the data from the at least one condition indicator sensor, the at least one usage indicator sensor, any other suitable data or information, or a combination thereof. The vehicle master model may represent a class of vehicle corresponding to a vehicle design associated with the vehicle 10. The vehicle specific model may be generated based on the vehicle master model and at least one initial parameter corresponding to at least one end-of-line characteristic of the vehicle 10.

The controller 100 may identify, using the vehicle specific model, at least one usage trend of the vehicle 10. The systems and methods described herein may be configured to determine an estimate of a remaining useful life of at least one aspect of the vehicle based on the at least one usage trend of the vehicle 10.

The systems and methods described herein may be configured to receive data from a health management system associated with a vehicle manufacturer logistics system. The systems and methods described herein may be configured to determine the estimate of the remaining useful life of the at least one aspect of the vehicle further based on the data from the health management system.

The systems and methods described herein may be configured to determine the estimate of the remaining useful life of the vehicle further based on at least one physics based metric. The systems and methods described herein may be configured to identify, using the vehicle specific model, at least one hidden value reducing failure of the vehicle. The systems and methods described herein may be configured to determine a monetary value of the vehicle based on the at least one hidden value reducing failure of the vehicle and the estimate of the remaining useful life of the at least one aspect of the vehicle.

In some embodiments, the controller 100 and/or the computing device may perform the methods described herein. However, the methods described herein as performed by the controller 100 and/or the computing device are not meant to be limiting, and any type of software executed on a controller or processor can perform the methods described herein without departing from the scope of this disclosure. For example, a controller, such as a processor executing software within a computing device, can perform the methods described herein.

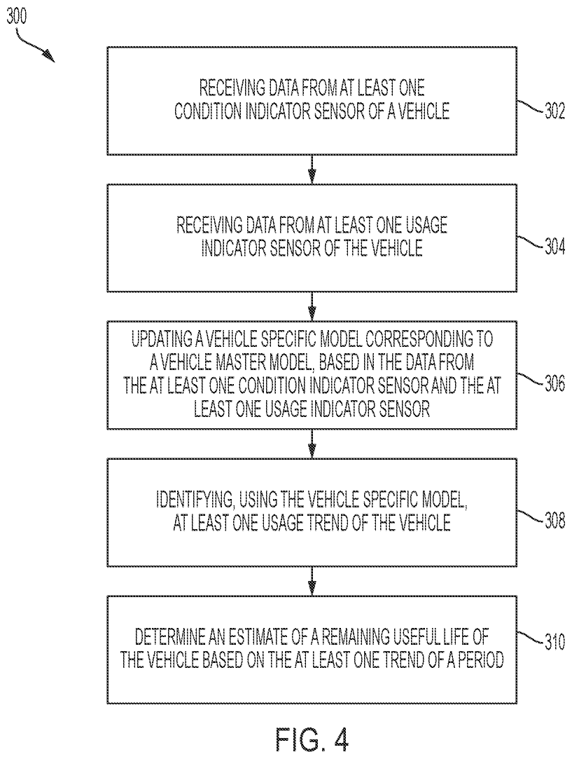

FIG. 4 is a flow diagram generally illustrating a vehicle analytics method 300 according to the principles of the present disclosure. At 302, the method 300 receives data from at least one condition indicator sensor of a vehicle. For example, the controller 100 may receive data from the at least one condition indicator sensor of the vehicle 10.

At 304, the method 300 receives data from at least one usage indicator sensor of the vehicle. For example, the controller 100 may receive data from the at least one usage indicator sensor of the vehicle 10.

At 306, the method 300 updates a vehicle specific model corresponding to a vehicle master model, based on the data from the at least one condition indicator sensor and the at least one usage indicator sensor. For example, the computing device may update the vehicle specific model corresponding to the vehicle master model, based on the data from the at least one condition indicator sensor and the at least one usage indicator sensor.

At 308, the method 300 identifies, using the vehicle specific model, at least one usage trend of the vehicle. For example, the computing device may identify, using the vehicle specific model, the at least one usage trend of the vehicle 10.

At 310, the method 300 determines an estimate of a remaining useful life of at least one aspect of the vehicle based on the at least one usage trend of the vehicle. For example, the computing device may determine the estimate of the RUL of at least one aspect of the vehicle 10 based on the at least one usage trend of the vehicle.

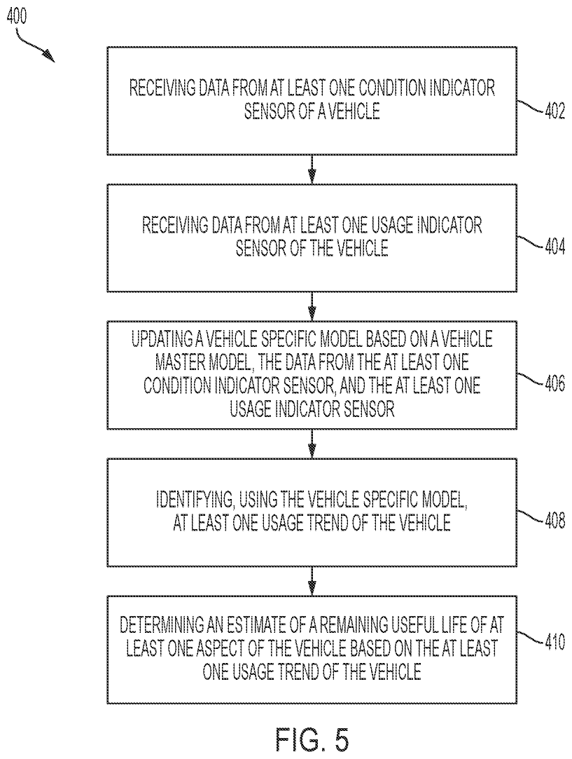

FIG. 5 is a flow diagram generally illustrating an alternative vehicle analytics method 400 according to the principles of the present disclosure. At 402, the method 400 receives data from at least one condition indicator sensor of a vehicle. For example, the controller 100 may receive the data from the at least one condition indicator sensor of the sensors 106 of the vehicle 10.

At 404, the method 400 receives data from at least one usage indicator sensor of the vehicle. For example, the controller 100 may receive the data from the at least one usage indicator sensor of the sensors 106 of the vehicle 10.

At 406, the method 400 updates a vehicle specific model based on a vehicle master model, the data from the at least one condition indicator sensor, and the at least one usage indicator sensor. For example, the controller 100 may update the vehicle specific model based on the vehicle master model, the data from the at least one condition indicator sensor, and the at least one usage indicator sensor. The vehicle master model may represent a class of vehicle corresponding to a vehicle design associated with the vehicle 10 and the vehicle specific model may be generated based on the vehicle master model and at least one initial parameter corresponding to at least one end-of-line characteristic of the vehicle 10.

At 408, the method 400 identifies, using the vehicle specific model, at least one usage trend of the vehicle. For example, the controller 100 may identify, using the vehicle specific model, the at least one usage trend of the vehicle 10.

At 410, the method 400 determines an estimate of a remaining useful life of at least one aspect of the vehicle based on the at least one usage trend of the vehicle. For example, the controller 100 may determine the estimate of the remaining useful life of the at least one aspect of the vehicle 10 based on the at least one usage trend of the vehicle 10.

In some embodiments, a method for vehicle analytics includes receiving data from at least one condition indicator sensor of a vehicle and receiving data from at least one usage indicator sensor of the vehicle. The method also includes updating a vehicle specific model corresponding to a vehicle master model, based on the data from the at least one condition indicator sensor and the at least one usage indicator sensor. The method also includes identifying, using the vehicle specific model, at least one usage trend of the vehicle and determining an estimate of a remaining useful life of at least one aspect of the vehicle based on the at least one usage trend of the vehicle.

In some embodiments, the at least one condition indicator sensor at least one component of the vehicle. In some embodiments, the at least one component corresponds to a steering system of the vehicle. In some embodiments, the data corresponding to the at least one usage indicator sensor indicates a usage of a component of the vehicle associated with the at least one usage indicator sensor. In some embodiments, the method also includes receiving data from a health management system associated with a vehicle manufacturer logistics system. In some embodiments, the method also includes determining the estimate of the remaining useful life of the vehicle further based on at least one physics based metric. In some embodiments, the method also includes identifying, using the vehicle specific model, at least one hidden value reducing failure of the vehicle. In some embodiments, the method also includes determining a monetary value of the vehicle based on the at least one hidden value reducing failure of the vehicle and the estimate of the remaining useful life of the at least one aspect of the vehicle.

In some embodiments, a method for vehicle analytics includes receiving data from at least one condition indicator sensor of a vehicle, receiving data from at least one usage indicator sensor of the vehicle, and updating a vehicle specific model based on a vehicle master model, the data from the at least one condition indicator sensor, and the at least one usage indicator sensor, the vehicle master model represents a class of vehicle corresponding to a vehicle design associated with the vehicle and the vehicle specific model is generated based on the vehicle master model and at least one initial parameter corresponding to at least one end-of-line characteristic of the vehicle. The method also includes identifying, using the vehicle specific model, at least one usage trend of the vehicle, and determining an estimate of a remaining useful life of at least one aspect of the vehicle based on the at least one usage trend of the vehicle.

In some embodiments, the at least one condition indicator sensor is associated with at least one component of the vehicle. In some embodiments, the at least one component corresponds to a steering system of the vehicle. In some embodiments, the data corresponding to the at least one usage indicator sensor indicates a usage of a component of the vehicle associated with the at least one usage indicator sensor. In some embodiments, the method also includes receiving data from a health management system associated with a vehicle manufacturer logistics system. In some embodiments, the method also includes determining the estimate of the remaining useful life of the at least one aspect of the vehicle further based on the data from the health management system. In some embodiments, the method also includes determining the estimate of the remaining useful life of the vehicle further based on at least one physics based metric. In some embodiments, the method also includes identifying, using the vehicle specific model, at least one hidden value reducing failure of the vehicle. In some embodiments, the method also includes determining a monetary value of the vehicle based on the at least one hidden value reducing failure of the vehicle and the estimate of the remaining useful life of the at least one aspect of the vehicle.

In some embodiments, a system for vehicle analytics includes a processor and a memory. The memory includes instructions that, when executed by the processor, cause the processor to: receive data from at least one condition indicator sensor of a vehicle; receive data from at least one usage indicator sensor of the vehicle; update a vehicle specific model based on a vehicle master model, the data from the at least one condition indicator sensor, and the at least one usage indicator sensor, the vehicle master model represents a class of vehicle corresponding to a vehicle design associated with the vehicle and the vehicle specific model is generated based on the vehicle master model and at least one initial parameter corresponding to at least one end-of-line characteristic of the vehicle; identify, using the vehicle specific model, at least one usage trend of the vehicle; and determine an estimate of a remaining useful life of at least one aspect of the vehicle based on the at least one usage trend of the vehicle.

In some embodiments, the at least one condition indicator sensor is associated with at least one component of the vehicle. In some embodiments, the at least one component corresponds to a steering system of the vehicle. In some embodiments, the data corresponding to the at least one usage indicator sensor indicates a usage of a component of the vehicle associated with the at least one usage indicator sensor. In some embodiments, the instructions further cause the processor to receive data from a health management system associated with a vehicle manufacturer logistics system. In some embodiments, the instructions further cause the processor to determine the estimate of the remaining useful life of the at least one aspect of the vehicle further based on the data from the health management system. In some embodiments, the instructions further cause the processor to determine the estimate of the remaining useful life of the vehicle further based on at least one physics based metric. In some embodiments, the instructions further cause the processor to identify, using the vehicle specific model, at least one hidden value reducing failure of the vehicle. In some embodiments, the instructions further cause the processor to determine a monetary value of the vehicle based on the at least one hidden value reducing failure of the vehicle and the estimate of the remaining useful life of the at least one aspect of the vehicle.

In some embodiments, an apparatus for vehicle analytics includes a processor and a memory. The memory includes instructions that, when executed by the processor, cause the processor to: receive data from at least one condition indicator sensor associated with at least one component of a steering system of a vehicle; receive data from at least one usage indicator sensor of the vehicle; receive data from a health management system associated with a vehicle manufacturer logistics system; update a vehicle specific model based on a vehicle master model, the data from the at least one condition indicator sensor, and the at least one usage indicator sensor, the vehicle master model represents a class of vehicle corresponding to a vehicle design associated with the vehicle and the vehicle specific model is generated based on the vehicle master model and at least one initial parameter corresponding to at least one end-of-line characteristic of the vehicle; identify, using the vehicle specific model, at least one usage trend of the vehicle; and determine an estimate of a remaining useful life of at least one aspect of the vehicle based on the at least one usage trend of the vehicle and the data from the health management system.

In some embodiments, the instructions further cause the processor to determine the estimate of the remaining useful life of the vehicle further based on at least one physics based metric.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for vehicle analytics, the method comprising:
receiving data from at least one condition indicator sensor of a vehicle;
receiving data from at least one usage indicator sensor of the vehicle;
updating a vehicle specific model based on a vehicle master model, the data from the at least one condition indicator sensor, and the at least one usage indicator sensor, the vehicle master model represents a class of vehicle corresponding to a vehicle design associated with the vehicle and the vehicle specific model is generated based on the vehicle master model and at least one initial parameter corresponding to at least one end-of-line characteristic of the vehicle;
identifying, using the vehicle specific model, at least one usage trend of the vehicle; and
determining an estimate of a remaining useful life of at least one aspect of the vehicle based on the at least one usage trend of the vehicle.

2. The method of claim 1, wherein the at least one condition indicator sensor is associated with at least one component of the vehicle.

3. The method of claim 2, wherein the at least one component corresponds to a steering system of the vehicle.

4. The method of claim 1, wherein the data corresponding to the at least one usage indicator sensor indicates a usage of a component of the vehicle associated with the at least one usage indicator sensor.

5. The method of claim 1, further comprising receiving data from a health management system associated with a vehicle manufacturer logistics system.

6. The method of claim 5, further comprising determining the estimate of the remaining useful life of the at least one aspect of the vehicle further based on the data from the health management system.

7. The method of claim 1, further comprising determining the estimate of the remaining useful life of the vehicle further based on at least one physics based metric.

8. The method of claim 1, further comprising identifying, using the vehicle specific model, at least one hidden value reducing failure of the vehicle.

9. The method of claim 8, further comprising determining a monetary value of the vehicle based on the at least one hidden value reducing failure of the vehicle and the estimate of the remaining useful life of the at least one aspect of the vehicle.

10. A system for vehicle analytics, the system comprising:
a processor; and
a memory including instructions that, when executed by the processor, cause the processor to:
receive data from at least one condition indicator sensor of a vehicle;
receive data from at least one usage indicator sensor of the vehicle;
update a vehicle specific model based on a vehicle master model, the data from the at least one condition indicator sensor, and the at least one usage indicator sensor, the vehicle master model represents a class of vehicle corresponding to a vehicle design associated with the vehicle and the vehicle specific model is generated based on the vehicle master model and at least one initial parameter corresponding to at least one end-of-line characteristic of the vehicle;
identify, using the vehicle specific model, at least one usage trend of the vehicle; and
determine an estimate of a remaining useful life of at least one aspect of the vehicle based on the at least one usage trend of the vehicle.

11. The system of claim 10, wherein the at least one condition indicator sensor is associated with at least one component of the vehicle.

12. The system of claim 11, wherein the at least one component corresponds to a steering system of the vehicle.

13. The system of claim 10, wherein the data corresponding to the at least one usage indicator sensor indicates a usage of a component of the vehicle associated with the at least one usage indicator sensor.

14. The system of claim 10, wherein the instructions further cause the processor to receive data from a health management system associated with a vehicle manufacturer logistics system.

15. The system of claim 14, wherein the instructions further cause the processor to determine the estimate of the remaining useful life of the at least one aspect of the vehicle further based on the data from the health management system.

16. The system of claim 10, wherein the instructions further cause the processor to determine the estimate of the remaining useful life of the vehicle further based on at least one physics based metric.

17. The system of claim 10, wherein the instructions further cause the processor to identify, using the vehicle specific model, at least one hidden value reducing failure of the vehicle.

18. The system of claim 17, wherein the instructions further cause the processor to determine a monetary value of the vehicle based on the at least one hidden value reducing failure of the vehicle and the estimate of the remaining useful life of the at least one aspect of the vehicle.

19. An apparatus for vehicle analytics, the apparatus comprising:
a processor; and
a memory including instructions that, when executed by the processor, cause the processor to:
receive data from at least one condition indicator sensor associated with at least one component of a steering system of a vehicle;
receive data from at least one usage indicator sensor of the vehicle;
receive data from a health management system associated with a vehicle manufacturer logistics system;
update a vehicle specific model based on a vehicle master model, the data from the at least one condition indicator sensor, and the at least one usage indicator sensor, the vehicle master model represents a class of vehicle corresponding to a vehicle design associated with the vehicle and the vehicle specific model is generated based on the vehicle master model and at least one initial parameter corresponding to at least one end-of-line characteristic of the vehicle;
identify, using the vehicle specific model, at least one usage trend of the vehicle; and
determine an estimate of a remaining useful life of at least one aspect of the vehicle based on the at least one usage trend of the vehicle and the data from the health management system.

20. The apparatus of claim 19, wherein the instructions further cause the processor to determine the estimate of the remaining useful life of the vehicle further based on at least one physics based metric.
